(19) United States
(12) Patent Application Publication
(10) Pub. No.: US 2026/0217039 A1
(43) Pub. Date: Jul. 30, 2026

(54) CONVEYING APPARATUS AND INKJET PRINTER

(71) Applicant: Takahiro KONISHI, Tokyo (JP)

(72) Inventor: Takahiro KONISHI, Tokyo (JP)

(73) Assignee: Ricoh Company, Ltd., Tokyo (JP)

(21) Appl. No.: 19/453,606

(22) Filed: Jan. 20, 2026

(30) Foreign Application Priority Data
Jan. 24, 2025 (JP) 2025-010644

(51) Int. Cl. B41J 13/08; B41J 13/00; B41J 13/03; B41J 13/22

(52) U.S. Cl. CPC B41J 13/08; B41J 13/0027; B41J 13/03; B41J 13/226

(57) ABSTRACT

A conveying apparatus includes: an endless belt that has a plurality of suction holes extending through an outer surface and an inner surface of the endless belt, and carries a recording medium on the outer surface of the endless belt; a driving roller configured to drive the endless belt; a driven roller configured to, together with the driving roller, tension and support the endless belt; a suction chamber that is disposed facing the inner surface of the endless belt and has a suction surface configured to suction the recording medium via the suction holes; a suction pump that is connected to the suction chamber and configured to create a negative pressure inside the suction chamber; and a conveying roller configured to contact the outer surface of the endless belt.

### CROSS-REFERENCE TO RELATED APPLICATIONS

The present application claims priority under 35 U.S. C § 119 to Japanese Patent Application No. 2025-010644 filed on Jan. 24, 2025, the contents of which are incorporated herein by reference in their entirety.

### BACKGROUND OF THE INVENTION

### 1. Field of the Invention

The present invention relates to a conveying apparatus and an inkjet printer.

### 2. Description of the Related Art

In the related art, a conveying apparatus is known that stably conveys a recording medium in an inkjet printer by creating a negative pressure in a space on an inner-surface side of an endless belt having an air-permeable structure, so that the recording medium is attracted onto an outer surface of the endless belt and conveyed.

For example, Japanese Unexamined Patent Application Publication No. 2010-052258 discloses a printing apparatus including: a head unit; an endless conveying belt that is provided on a downstream side of the head unit in a direction of conveying a printing medium and has a large number of small holes for attracting the printing medium by negative air pressure; a driving roller; a driven roller; a duct disposed directly below an inner peripheral surface of the endless conveying belt; and a suction fan.

However, in such a conveying apparatus as described above, a suction force is generated only in a region of the endless conveying belt above the duct, and no suction force is generated in regions above the driving roller or above the driven roller. Therefore, in particular, when a recording medium having a relatively small size close to the roller diameter of the driving roller or the driven roller passes above the driving roller or the driven roller, disadvantageously, a sufficient conveying force cannot be secured for the recording medium, and the recording medium cannot be delivered to a downstream process (paper ejection, drying, or the like). Herein, it is possible to provide a conveying roller for conveying a recording medium by nipping the recording medium between the conveying roller and the endless conveying belt. However, in this case, unless the printed ink is sufficiently dried, image disturbance disadvantageously occurs due to contact of the conveying roller with the printed ink.

### SUMMARY OF THE INVENTION

According to an embodiment of the present invention, a conveying apparatus includes: an endless belt that has a plurality of suction holes extending through an outer surface and an inner surface of the endless belt, and carries a recording medium on the outer surface of the endless belt; a driving roller configured to drive the endless belt; a driven roller configured to, together with the driving roller, tension and support the endless belt; a suction chamber that is disposed facing the inner surface of the endless belt and has a suction surface configured to suction the recording medium via the suction holes; a suction pump that is connected to the suction chamber and configured to create a negative pressure inside the suction chamber; and a conveying roller configured to contact the outer surface of the endless belt, in which the conveying roller includes: a through shaft extending in a direction along an axis of the driving roller; and at least two rollers that are rotatably supported by the through shaft, and each of the rollers is movable along the through shaft and contacts the outer surface of the endless belt in a region other than a region facing the suction surface.

### BRIEF DESCRIPTION OF THE DRAWINGS

FIG. 1 is a schematic configuration diagram illustrating an example of an inkjet printer for cut sheets according to an embodiment;

FIG. 2 is a front view illustrating a configuration example of a conveying apparatus according to an embodiment;

FIG. 3 is a view for explaining a relationship between the conveying apparatus and a recording medium according to an embodiment; and

FIG. 4 is a view for explaining a relationship between the conveying apparatus and a recording medium according to an embodiment.

### DESCRIPTION OF THE EMBODIMENTS

It is an object of an embodiment of the present invention to provide a conveying apparatus that is capable of stably conveying a printed recording medium while suppressing image disturbance.

Hereinafter, embodiments of the present invention will be described with reference to the accompanying drawings. Throughout the drawings, the same components are denoted by the same reference signs, and repeated descriptions are omitted as appropriate.

Note that the embodiments described below are not intended to limit the present invention. The dimensions, materials, shapes, relative arrangements, and the like of the components described below are not intended to limit the scope of the present invention, unless otherwise specified, but are presented merely by way of example. The sizes, positional relationships, and the like of the members illustrated in the drawings may be emphasized in order to clarify the description. The terms “image formation,” “recording,” and “printing” may be used interchangeably herein.

### Inkjet Printer

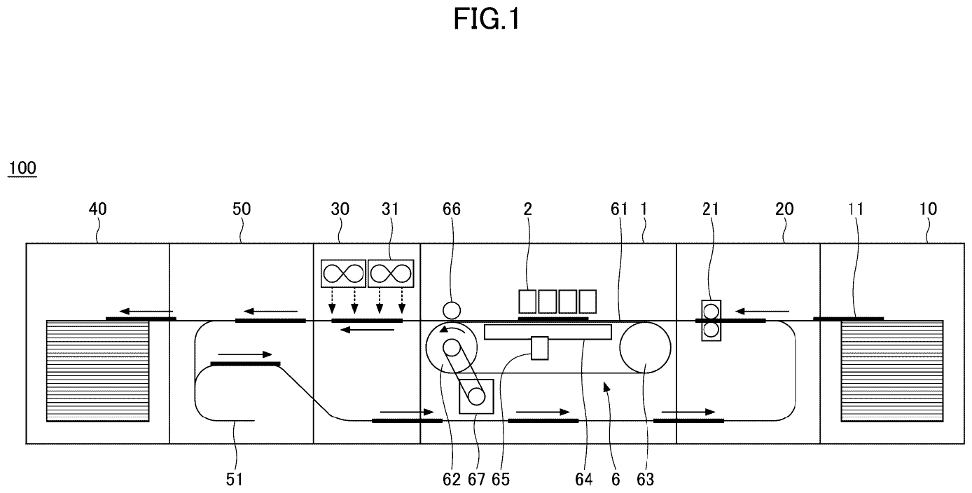

FIG. 1 is a schematic configuration diagram illustrating an example of an inkjet printer 100 for cut sheets according to the present embodiment. As illustrated in FIG. 1, the inkjet printer 100 of the present embodiment includes an ink head 2 and a conveying apparatus 6. The ink head 2 is configured to eject ink by an inkjet method, and the conveying apparatus 6 is configured to convey a recording medium 11.

Specifically, the inkjet printer 100 may be provided with an image forming unit 1, a paper feeding unit 10, and a registration adjusting unit 20. The image forming unit 1 includes the ink head 2 and the conveying apparatus 6. The paper feeding unit 10 is configured to feed the recording medium 11 from a stack. The registration adjusting unit 20 is configured to perform registration correction for the recording medium 11. The paper feeding unit 10 and the registration adjusting unit 20 are disposed upstream of the image forming unit 1 in a conveying direction of the recording medium 11. The inkjet printer 100 may be provided with a drying unit 30, a paper ejection unit 40, and a paper reversing and conveying unit 50 that are disposed downstream of the image forming unit 1 in the conveying direction of the recording medium 11. The drying unit 30 is configured to dry the recording medium 11 on which an image has been formed by the inkjet method. The paper ejection unit 40 is configured to eject the dried recording medium 11. The paper reversing and conveying unit 50 is for further forming an image on a back surface of the recording medium 11.

Next, a series of image forming operations performed by the inkjet printer 100 will be described for forming an image on the recording medium 11.

In FIG. 1, first, the recording medium 11 stacked in the paper feeding unit 10 is separated and picked up one by one. The paper feeding unit 10 may include, for example, an air-separating unit that uses air. The picked-up recording medium 11 is conveyed, in a direction toward the image forming unit 1, to the registration adjusting unit 20, which is located downstream in the conveying direction of the recording medium 11.

The recording medium 11 conveyed from the paper feeding unit 10 reaches the registration adjusting unit 20. Then, registration correction for the recording medium 11 is performed by a registration roller 21 provided inside the registration adjusting unit 20. The recording medium 11 that has undergone the registration correction in the registration adjusting unit 20 is conveyed to the image forming unit 1 at a predetermined timing.

The recording medium 11 that has undergone the registration correction and has been conveyed to the image forming unit 1 is conveyed onto an outer surface of an endless belt 61. A plurality of suction holes described later are formed in the endless belt 61, and the entire recording medium 11 can be retained in close contact with the outer surface of the endless belt 61 by air suction applied to a back surface of the recording medium 11. Then, the recording medium 11 retained in close contact with the outer surface of the endless belt 61 by air suction is conveyed toward the ink head 2 by rotation of the endless belt 61.

In the image forming unit 1, a plurality of ink heads 2 are arranged sequentially along the outer surface of the endless belt 61 and are each filled with ink of a predetermined color. The recording medium 11 retained on the outer surface of the endless belt 61 is conveyed below the ink heads 2 corresponding to the respective colors. Ink of each color is ejected from a nozzle of the corresponding ink head 2 at a predetermined timing to form an image on a front surface of the recording medium 11.

The recording medium 11 on which the image has been formed by the image forming unit 1 is conveyed to the drying unit 30 by the conveying apparatus 6. The drying unit 30 is provided with a dryer 31. When the recording medium 11 passes below the dryer 31, moisture in the ink is evaporated, and thus curling of the recording medium 11 can be prevented.

The recording medium 11 that has passed the drying unit 30 is conveyed to the paper ejection unit 40, where the recording medium 11 is stacked in an orderly manner. The paper reversing and conveying unit 50 is provided with a paper reversing unit 51. During duplex printing, the recording medium 11 is reversed at the paper reversing unit 51 and conveyed back to the image forming unit 1. After the paper reversing unit 51 has switched the conveying direction of the recording medium 11, the recording medium 11 is conveyed toward the image forming unit 1 by the paper reversing and conveying unit 50.

The registration correction is performed again for the recording medium 11 by the registration roller 21 before the recording medium 11 reaches the endless belt 61. The recording medium 11 that has undergone the registration correction is conveyed to the endless belt 61 and retained on the outer surface of the endless belt 61. In this state, the back surface of the recording medium 11, on which no image is formed, faces upward. Then, in the image forming unit 1, an image is formed by the ink heads 2 on the back surface of the recording medium 11, on which no image has been formed, the recording medium 11 being retained on the outer surface of the endless belt 61, in the same manner as described above.

In the same manner as in single-sided printing, the recording medium 11 that has passed the drying unit 30 is conveyed to the paper ejection unit 40, where the recording medium 11 is stacked in an orderly manner.

In the example illustrated in FIG. 1, the inkjet printer 100 includes the paper feeding unit 10, the registration adjusting unit 20, the image forming unit 1, the drying unit 30, the paper ejection unit 40, and the paper reversing and conveying unit 50, and may further include an additional functional unit. For example, the inkjet printer 100 may include a preprocessing unit configured to perform preprocessing before image formation. The registration adjusting unit 20 or the paper reversing and conveying unit 50 may be optional in the inkjet printer 100.

The material of the recording medium 11 is not limited, and may be any material to which ink can adhere, even temporarily, such as paper, thread, fiber, fabric, leather, metal, plastic, glass, wood, or ceramics. The recording medium 11 may be, for example, used for a film product, a cloth product such as clothing, a building material such as wallpaper or flooring, a leather product, or the like.

### Conveying Apparatus

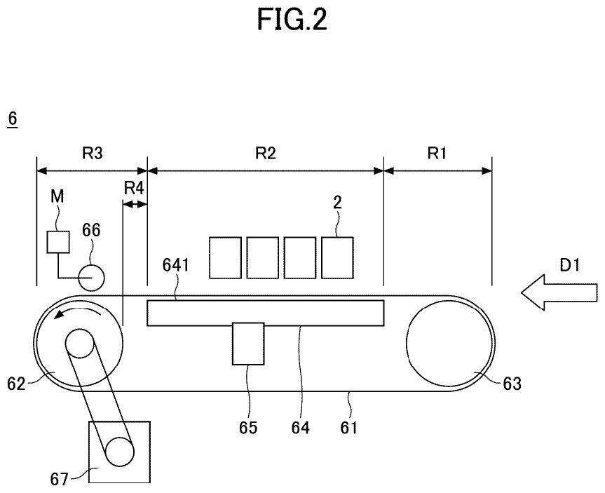

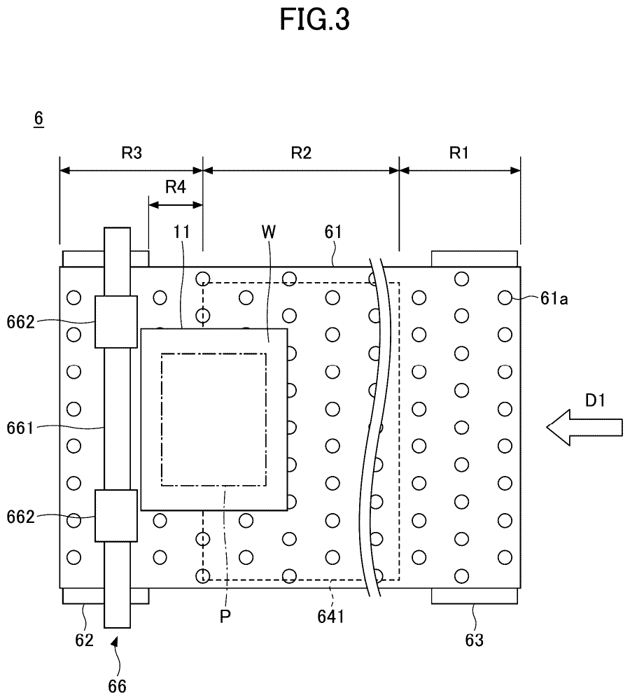

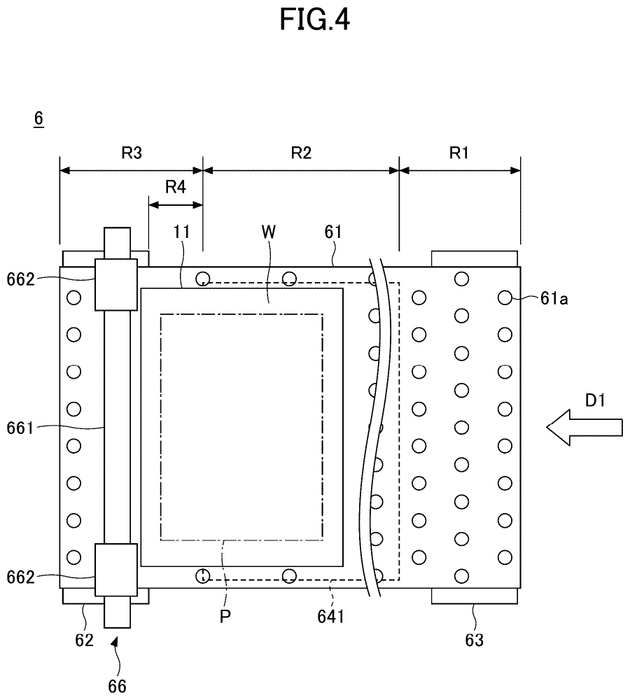

FIG. 2 is a front view illustrating a configuration example of the conveying apparatus 6 according to the present embodiment, and FIGS. 3 and 4 are views for explaining a relationship between the recording medium 11 and the conveying apparatus 6 according to the present embodiment. FIGS. 3 and 4 are plan views illustrating the conveying apparatus 6 as viewed in a direction perpendicular to a conveying surface of the endless belt 61.

As illustrated in FIGS. 1 and 2, the conveying apparatus 6 includes the endless belt 61, a driving roller 62, a driven roller 63, a suction chamber 64, a suction pump 65, and a conveying roller 66. The conveying apparatus 6 may also include a motor (a motor for a driving roller) 67 for driving the driving roller 62.

The driving roller 62 drives the endless belt 61, and the driven roller 63, together with the driving roller 62, tensions and supports the endless belt 61. The endless belt 61 carries the recording medium 11 on the outer surface of the endless belt 61 in a region that spans between the driving roller 62 and the driven roller 63. When the driving roller 62 is driven by the motor 67 in a direction of an arrow in FIG. 2, the endless belt 61 travels so that the outer surface of the endless belt 61 moves in a recording-medium conveying direction D1 (hereinafter sometimes referred to as “the conveying direction D1”).

As illustrated in FIGS. 3 and 4, the endless belt 61 has a plurality of suction holes 61a that extend through the outer surface and the inner surface of the endless belt 61. The number, shape, and size of the suction holes 61a are not limited to the examples illustrated in FIGS. 3 and 4. For example, the number, shape, and size may be selected depending on a magnitude of the negative pressure to be generated. The plurality of suction holes 61a may be uniformly or non-uniformly arranged over an entire area of the endless belt 61.

In the examples illustrated in FIGS. 3 and 4, the suction holes 61a are provided from one end to the other end in a width direction of the endless belt 61 (the direction along the axis of the driving roller 62 or the driven roller 63), but may be provided only in a region between two rollers 662 disposed at positions illustrated in FIG. 4 in the width direction of the endless belt 61.

The endless belt 61 may be made of a metal such as stainless steel.

A length of the endless belt 61 in the width direction should be equal to or greater than a length of the recording medium 11 in the width direction (i.e., the direction along the axis of the driving roller 62 or the driven roller 63).

The suction chamber 64 is disposed between the driving roller 62 and the driven roller 63, inside the loop of the endless belt 61 (on the inner surface side of the endless belt 61). The suction chamber 64 has a suction surface 641 that faces the inner surface of the endless belt 61 and comes into contact with the inner surface to suction the recording medium 11 through the suction holes 61a. The suction surface 641 should have an air-permeable configuration. For example, the suction surface 641 may have an opening or may have a mesh structure formed by a plurality of holes or linear members.

The suction pump 65 is connected to the suction chamber 64 and creates a negative pressure inside the suction chamber 64 by suction. When a negative pressure is created inside the suction chamber 64 by suction from the suction pump 65, a suction airflow directed toward the inside of the suction chamber 64 is generated above the suction chamber 64. Due to this suction airflow, the inner surface (inner peripheral surface) of the endless belt 61 is attracted to the suction surface 641 of the suction chamber 64 by suction, and the endless belt 61 moves while sliding on the suction surface 641.

Due to the suction airflow generated above the suction chamber 64, a suction airflow is also generated in each of the suction holes 61a formed in the endless belt 61. Thus, for example, the recording medium 11 conveyed from the registration adjusting unit 20 and delivered onto the outer surface of the endless belt 61 is attracted onto the outer surface of the endless belt 61 by the suction airflow. Then, as the outer surface of the endless belt 61 moves, the recording medium 11 is printed by the ink head 2, and is thereafter separated from the outer surface of the endless belt 61 and delivered to, for example, the drying unit 30.

That is, as illustrated in FIGS. 2 and 3, the endless belt 61 has a first region R1, a second region R2, and a third region R3. The second region R2 is a region that faces the suction surface 641 and on which a suction force acts. The first region R1 is a region that extends in the conveying direction D1 from the upstream end of the second region R2 to the upstream end of the driven roller 63 and on which no suction force acts. The third region R3 is a region that extends in the conveying direction D1 from the downstream end of the second region R2 to the downstream end of the driving roller 62 and on which no suction force acts.

The conveying roller 66 contacts the outer surface of the endless belt 61. As illustrated in FIGS. 2 and 3, the conveying roller 66 has a single through shaft 661 and at least two rollers 662. The through shaft 661 extends in a direction along the axis of the driving roller 62, and the rollers 662 are rotatably supported by the through shaft 661. Each of the rollers 662 is movable along the through shaft 661 and contacts the outer surface of the endless belt 61 in a region other than a region facing the suction surface 641. The rollers 662 may be movable manually or automatically.

As illustrated in FIG. 3, when a recording medium 11 having a relatively small size is carried on and conveyed by the outer surface of the endless belt 61, the rollers 662 are moved along the through shaft 661 so as to contact a margin W that extends along an outer periphery of a printed region P of the recording medium 11. Thus, the positions of the rollers 662 can be adjusted. In the example illustrated in FIG. 3, the positions of the two rollers 662 are adjusted so as to contact the margin W located on opposite sides of the recording medium 11 in the width direction. Note that the printed region P indicates an area that has already been printed by the ink head 2.

As illustrated in FIG. 4, when a recording medium 11 having a relatively large size is carried on and conveyed by the outer surface of the endless belt 61, the rollers 662 are moved along the through shaft 661 toward side edges of the endless belt 61 in the width direction, from the positions illustrated in FIG. 3, so as to contact a margin W of the recording medium 11. Thus, the positions of the rollers 662 can be adjusted. In the example illustrated in FIG. 4, the positions of the two rollers 662 are adjusted so as to contact the margin W located on opposite sides of the recording medium 11 in the width direction.

Examples of the recording medium 11 having a relatively small size include a postcard-sized recording medium. Examples of the recording medium 11 having a relatively large size include a B2-sized recording medium.

As described above, the rollers 662 can be moved, according to the size of the recording medium 11 or the margin setting of the recording medium 11, to positions where the rollers 662 contact the margin W. In this manner, the rollers 662 contact only the margin W of the recording medium 11, and the recording medium 11 can be conveyed while being nipped between the rollers 662 and the endless belt 61.

The roller 662 may contact the outer surface of the endless belt 61 in a region other than the region where the endless belt 61 faces the suction surface 641 of the suction chamber 64. In the examples illustrated in FIGS. 2 to 4, the rollers 662 contact the outer surface of the endless belt 61 in the third region R3. Specifically, the rollers 662 are disposed at positions where the rollers 662 face the driving roller 62 via the endless belt 61. The rollers 662 may contact the outer surface of the endless belt 61 in at least one of the first region R1 or the third region R3.

The conveying apparatus 6 may include an intermediate roller (not illustrated) that is disposed between the suction chamber 64 and the driving roller 62 and contacts the inner surface of the endless belt 61. In this case, the rollers 662 may be disposed at positions facing the intermediate roller via the endless belt 61. That is, the endless belt 61 may have a fourth region R4 which is a region located between the downstream end of the second region R2 in the conveying direction D1 and a contact plane of an outer peripheral surface of the driving roller 62 at the upstream end of the driving roller 62, and the rollers 662 may contact the outer surface of the endless belt 61 in the fourth region R4.

In the examples illustrated in FIGS. 2 to 4, the ink heads 2 are disposed so as to face the second region R2 of the endless belt 61. However, the ink heads 2 may be disposed upstream of the first region R1 of the endless belt 61 in the conveying direction D1. When the ink heads 2 are disposed so as to face the second region R2 of the endless belt 61, that is, when printing is performed on the recording medium 11 in the second region R2, the rollers 662 may contact the outer surface of the endless belt 61 in the third region R3. When the ink heads 2 are disposed upstream of the first region R1 of the endless belt 61 in the conveying direction D1, that is, when printing is performed on the recording medium 11 upstream of the first region R1 in the conveying direction D1, the rollers 662 may contact the outer surface of the endless belt 61 in the first region R1.

The conveying apparatus 6 may include two conveying rollers 66, in which the rollers 662 of one conveying roller 66 may contact the outer surface of the endless belt 61 in the first region R1, and the rollers 662 of the other conveying roller 66 may contact the outer surface of the endless belt 61 in the third region R3.

In the direction along the axis of the through shaft 661, a length of the rollers 662 may be approximately the same as the lengths of the respective margins W that extend along the opposite sides of the recording medium 11, and may be, for example, between 3 mm to 10 mm.

The conveying apparatus 6 may also include a motor (a motor for a conveying roller) M for driving the conveying roller 66. The conveying roller 66 may be driven by the drive force of the driving roller 62, or may be driven by a motor M different from the motor 67.

As described above, the conveying apparatus 6 includes the endless belt 61 having the plurality of suction holes 61a and carrying the recording medium 11 on the outer surface of the endless belt 61, the driving roller 62, the driven roller 63, the suction chamber 64 having the suction surface 641, the suction pump 65, and the conveying roller 66. The conveying roller 66 includes the through shaft 661 and at least two rollers 662. The rollers 662 are movable along the through shaft 661 contact the outer surface of the endless belt 61 in a region other than the region facing the suction surface 641.

With this configuration, the rollers 662 contact the outer surface of the endless belt 61 in the region where the suction force does not act. Thus, the recording medium 11 is nipped between the rollers 662 and the endless belt 61 even when the recording medium 11 is carried in the region. Therefore, a sufficient conveying force can be secured for the recording medium 11. In particular, the conveying apparatus 6 can secure a sufficient conveying force for the recording medium 11 having a relatively small size close to the roller diameter of the driving roller 62 or the driven roller 63, enabling the recording medium 11 to be delivered to a downstream process (paper ejection, drying, or the like).

The rollers 662 can be movable along the through shaft 661. Thus, according to the size of the recording medium 11 or the margin setting of the recording medium 11, the rollers 662 can be moved to the positions where the rollers 662 contact only the margin W, avoiding the printed region P of the recording medium 11 after printing has been performed. Accordingly, the conveying apparatus 6 can stably convey the printed recording medium 11 while suppressing image disturbance.

As compared with a case where the conveying apparatus 6 does not include the conveying roller 66, the area of the region where the suction force acts on the endless belt 61 can be reduced, and the suction chamber 64 or the suction pump 65 can be reduced in size. This saves energy.

Each roller 662 can be configured to contact the outer surface of the endless belt 61 (third region R3) in a region extending from the downstream end of the region facing the suction surface 641 to the downstream end of the driving roller 62 in the conveying direction D1 of the recording medium 11. With this configuration, the conveying apparatus 6 is suitable for an inkjet printer in which the ink head 2 is disposed so as to face the second region R2 of the endless belt 61, that is, for an inkjet printer in which printing is performed on the recording medium 11 in the second region R2.

Specifically, even if an ordinary conveying roller is provided to contact the first region R1, image disturbance does not occur regardless of the position of the roller since printing is not performed on the recording medium 11 yet. However, image disturbance occurs in the third region R3 when the roller contacts the printed image since printing has been performed on the recording medium 11. In the conveying apparatus 6 of the present embodiment, since each roller 662 can contact only the margin W of the printed recording medium 11 on the outer surface in the third region R3, the printed recording medium 11 can be stably conveyed while image disturbance is suppressed.

When the conveying roller is provided to contact the second region R2, ink head division and arrangement of rollers between divided ink heads are necessary in order to prevent the rollers from contacting the printed image. In the conveying apparatus 6 of the present embodiment, the printed recording medium 11 can be conveyed while image disturbance is suppressed, without rearranging a new ink head.

The conveying roller 66 can be disposed at a position facing the driving roller 62 via the endless belt 61. With this configuration, the driving roller 62 can also serve as a facing member for the conveying roller 66 so that the conveying apparatus 6 does not need to be provided a dedicated facing member. Thus, the number of components can be reduced, or the circumference of the endless belt 61 can be reduced. This can reduce costs.

The endless belt 61 may be made of stainless steel. Thus, the endless belt 61 can have enhanced durability against external force and cope with high suction pressure.

The conveying apparatus 6 can include the motor M that is configured to drive the conveying roller 66. With this configuration, the conveying apparatus 6 can stably convey the printed recording medium 11 for a wider variety of recording media, including those having a relatively small thickness, while suppressing image disturbance.

The inkjet printer 100 is for cut sheets and includes the conveying apparatus 6 of the present embodiment. With this configuration, the inkjet printer 100 can stably convey the printed recording medium 11 while suppressing image disturbance.

Aspects of the present invention are, for example, as follows.

### <First Aspect>

A conveying apparatus, including:
an endless belt that has a plurality of suction holes extending through an outer surface and an inner surface of the endless belt, and carries a recording medium on the outer surface of the endless belt;
a driving roller configured to drive the endless belt;
a driven roller configured to, together with the driving roller, tension and support the endless belt;
a suction chamber that is disposed facing the inner surface of the endless belt and has a suction surface configured to suction the recording medium via the suction holes;
a suction pump that is connected to the suction chamber and configured to create a negative pressure inside the suction chamber; and
a conveying roller configured to contact the outer surface of the endless belt, in which
the conveying roller includes:
a through shaft extending in a direction along an axis of the driving roller; and at least two rollers that are rotatably supported by the through shaft, and
each of the rollers is movable along the through shaft and is configured to contact the outer surface of the endless belt in a region other than a region facing the suction surface.

### <Second Aspect>

The conveying apparatus according to the first aspect, in which each of the rollers is configured to contact the outer surface of the endless belt in a region extending from a downstream end of the region facing the suction surface to a downstream end of the driving roller in a conveying direction of the recording medium.

### <Third Aspect>

The conveying apparatus according to the first aspect or the second aspect, in which each of the rollers is disposed at a position facing the driving roller via the endless belt.

### <Fourth Aspect>

The conveying apparatus according to any one of the first aspect to the third aspect, in which the endless belt contains stainless steel.

### <Fifth Aspect>

The conveying apparatus according to any one of the first aspect to the fourth aspect, further comprising a motor configured to drive the conveying roller.

### <Sixth Aspect>

An inkjet printer for cut sheets, the printer comprising: the conveying apparatus of any one of the first aspect to the fifth aspect.

The conveying apparatus according to an embodiment of the present invention can stably convey a printed recording medium while suppressing image disturbance.

Although the embodiments of the present invention have been described above in detail, the present disclosure is not limited to the above-described embodiments. Various modifications and substitutions can be made to the above-described embodiments without departing from the scope of claims.

What is claimed is:

1. A conveying apparatus, comprising:
an endless belt that has a plurality of suction holes extending through an outer surface and an inner surface of the endless belt, and carries a recording medium on the outer surface of the endless belt;
a driving roller configured to drive the endless belt;
a driven roller configured to, together with the driving roller, tension and support the endless belt;
a suction chamber that is disposed facing the inner surface of the endless belt and has a suction surface configured to suction the recording medium via the suction holes;
a suction pump that is connected to the suction chamber and configured to create a negative pressure inside the suction chamber; and
a conveying roller configured to contact the outer surface of the endless belt, wherein
the conveying roller includes: a through shaft extending in a direction along an axis of the driving roller; and at least two rollers that are rotatably supported by the through shaft, and
each of the rollers is movable along the through shaft and contacts the outer surface of the endless belt in a region other than a region facing the suction surface.

2. The conveying apparatus according to claim 1, wherein
each of the rollers is configured to contact the outer surface of the endless belt in a region extending from a downstream end of the region facing the suction surface to a downstream end of the driving roller in a conveying direction of the recording medium.

3. The conveying apparatus according to claim 2, wherein
each of the rollers is disposed at a position facing the driving roller via the endless belt.

4. The conveying apparatus according to claim 3, wherein the endless belt contains stainless steel.

5. The conveying apparatus according to claim 4, further comprising a motor configured to drive the conveying roller.

6. An inkjet printer for cut sheets, the printer comprising:
the conveying apparatus of claim 1.
